(19) United States
(12) Patent Application Publication
(10) Pub. No.: US 2023/0145464 A1
(43) Pub. Date: May 11, 2023

(54) SYSTEM AND METHOD FOR ORGANIZATION AND CLASSIFICATION OF APPLICATION SECURITY VULNERABILITIES

(71) Applicant: Abhay Bhargav, Bangalore (IN)

(72) Inventor: Abhay Bhargav, Bangalore (IN)

(21) Appl. No.: 17/750,955

(22) Filed: May 23, 2022

Related U.S. Application Data
(63) Continuation-in-part of application No. 16/895,411, filed on Jun. 8, 2020, now abandoned.

(30) Foreign Application Priority Data
Jun. 11, 2019 (IN) 201941023183

(51) Int. Cl. G06F 21/57; G06F 21/56

(52) U.S. Cl. CPC G06F 21/577; G06F 21/563; G06F 2221/033

(57) ABSTRACT

The various embodiments herein provide a system and a method for identifying and fixing security vulnerabilities in an application. The embodiments herein also provide a system and a method that enables users to capture a plurality of information related to the vulnerabilities, identify and fix vulnerabilities in their applications with ease. The embodiments herein enable linking application security vulnerabilities to features and threat models. The embodiments herein are also configured to correlate vulnerabilities with aliases and derive security test cases from a vulnerability. The embodiments herein also enable identifying appropriate security test cases and identify specific payloads to attack and find the vulnerability. The embodiments herein also provide methods that enable developers to identify coding patterns to protect against vulnerabilities and creating application security checklists.

### CROSS-REFERENCE TO RELATED APPLICATIONS

This application is a continuation-in-part of U.S. application Ser. No. 16/895,411, filed Jun. 8, 2020, and this application claims the priority of the Indian Provisional Patent Application filed on Jun. 11, 2019 with the number 201941023183 and entitled, “SYSTEM AND METHOD FOR ORGANIZATION AND CLASSIFICATION OF APPLICATION SECURITY VULNERABILITIES”, and the contents of which are included in entirety as reference herein.

### BACKGROUND

### Description of the Related Art

The embodiments herein are generally related to a system and method for organization and classification of application security vulnerabilities. The embodiments herein are particularly related to a system and a method for identifying and fixing security vulnerabilities in an application.

### Description of the Related Art

Organizations developing software face a plurality of challenges, of which, handling the security vulnerabilities in their applications is a vital one. The challenges include finding the vulnerabilities and testing for it, correlating the vulnerabilities with similar vulnerabilities found by various vulnerability scanning tools, aggregating the vulnerabilities across multiple systems, identifying fixes and mitigations to address these vulnerabilities, linking these vulnerabilities to existing threat models and linking these vulnerabilities to common feature patterns.

Currently available solutions only capture vulnerability information and some information pertaining to the code or vulnerability metadata. They are not designed to handle application vulnerabilities linked with threat models (mapping security vulnerabilities to the features), application vulnerabilities correlated with aliases (aliases generated based on different names and nomenclatures from multiple vulnerability assessment tools), application security test cases generated from the vulnerability information, vulnerability impact on specific infrastructure elements that are used to host and interact with applications, the vulnerability and its impact in specific, publicly known security breaches and publicly released bug bounty reports and the vulnerability's effect on the organization's compliance/regulatory requirements.

Hence, there exists a need for a system and a method that enables users to capture a plurality of information related to the vulnerabilities, identify and fix vulnerabilities in their applications with ease. There also exists a need for identifying best practices of deploying an application considering specific vulnerabilities relevant to the use-case. Also, there exists a need correlate between organizational risk due to a vulnerability and information from predictive analysis based on breach data or bug-bounty data. Further, there is a need to provide training to a plurality of stakeholders relating to the vulnerabilities. There is also a need for methods that enable capturing common attack payloads to identify the vulnerabilities, capturing common security test cases to identify the vulnerability with automated and manual testing and capturing tactical and strategic fixes and remediation information for the vulnerability. There is also a need for methods that enable linking vulnerability to common threat models and to common software features such as “Login”, “Checkout Shopping Cart” etc.

The above-mentioned shortcomings, disadvantages and problems are addressed herein and which will be understood by reading and studying the following specification.

### OBJECT OF THE EMBODIMENTS HEREIN

The primary object of the embodiments herein is to provide a system and a method for identifying, classifying, correlating, mapping and fixing security vulnerabilities in an application.

Another object of the embodiments herein is to provide a system and a method that enables users to capture a plurality of information related to the vulnerabilities, identify and fix vulnerabilities in their applications with ease.

Yet another object of the embodiments herein is to provide methods that enable capturing common attack payloads to identify the vulnerabilities, capturing common security test cases to identify the vulnerability with automated and manual testing and capturing tactical and strategic fixes and remediation information for the vulnerability.

Yet another object of the embodiments herein is to provide methods for vulnerability remediation and enabling security training for developer application.

Yet another object of the embodiments herein is to provide methods that enable identifying security requirements for software features.

Yet another object of the embodiments herein is to provide methods that enable security testers to identify appropriate security test cases, identify specific payloads to attack and find the vulnerability.

Yet another object of the embodiments herein is to provide methods that enable developers to identify coding patterns to protect against vulnerabilities and creating application security checklists.

Yet another object of the embodiments herein is to provide methods for enabling information technology (IT) operations personnel to identify deployment of best practices based on a particular vulnerability by identifying specific impact to the IT infrastructure components based on a given vulnerability.

These and other objects and advantages of the embodiments herein will become readily apparent from the following summary and the detailed description taken in conjunction with the accompanying drawings.

### SUMMARY

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The other objects and advantages of the embodiments herein will become readily apparent from the following description taken in conjunction with the accompanying drawings.

The various embodiments of the embodiments herein provide a system and a method for identifying and fixing security vulnerabilities in an application. The embodiments herein also provide a system and a method that enables users to capture a plurality of information related to the vulnerabilities, identify and fix vulnerabilities in their applications with ease. The embodiments herein also provide methods that enable capturing common attack payloads to identify the vulnerabilities, capturing common security test cases to identify the vulnerability with automated and manual testing and capturing tactical and strategic fixes and remediation information for the vulnerability.

According to one embodiment herein, a system is provided for organization, identification, classification and remediation of security vulnerabilities in computer applications. The system comprises a plurality of computing devices and a digital storage mechanism. The computing devices are enabled to run computer applications. The digital storage mechanism is configured with a risk language library, wherein the digital storage mechanism is configured to communicably couple with the plurality of computing devices through wired or wireless means. The risk language library is configured to enable organization, identification, classification and remediation of security vulnerabilities in computer applications that run on the plurality of computing devices.

According to one embodiment herein, the risk language library comprises a metadata module, a technology module, a features module, an examples module, a mitigations module, a breaches module, a bug bounty activity module and a compliance module. The metadata module further comprises sub-modules relating to common weakness enumerations (CWEs), related CWEs, name, description, aliases and common vulnerabilities and exposures (CVEs). The technology module further comprises a component module that is sub-categorized based on characteristics such as name, payloads, hardening, questions, CVEs, categories, tools and advisories, and wherein the hardening is further sub-categorized as description, reference and advisory. The features module further comprises sub-modules relating to feature name, feature type, impact and attributes. The examples module further comprises a sub-module relating to code, and wherein the code is classified as good code and bad code. The mitigations module is further sub-categorized, including generic mitigations by stage. The breaches module further comprises sub-modules relating to name of the breach, attack vectors used by CWE and technique. The bug bounty activity module further comprises sub-modules relating to bounty name, company, bounty date, technique and severity. The compliance module further comprises sub-modules relating to standard name, standard identification reference and industry applicability.

According to one embodiment herein, the risk language library is configured for identifying security requirements for software features and identifying coding patterns to protect against vulnerabilities. The risk language library is also configured to enable security testers to identify appropriate security test cases, finding vulnerabilities by identifying specific payloads, creating application security checklists and provide training on application security for application developers.

According to one embodiment herein, the risk language library is configured for capturing application vulnerabilities in a database, linking application security vulnerabilities to features and threat models, correlating vulnerabilities with aliases for application security and derive test cases from a vulnerability.

According to one embodiment herein, a method for organizing, identifying, classifying and remediating security vulnerabilities in computer applications. The method comprises the following steps: identifying approaches to find and exploit a vulnerability for fixing and remediating the vulnerability; determining impact and influence of the vulnerability on a product feature of the computer applications; identifying common remediation patterns per feature and approaches to attack feature through common vulnerabilities; and determining common threat models to a feature and common attacks leading to threat models.

According to one embodiment herein, identifying approaches to find and exploit a vulnerability for fixing and remediating the vulnerability further includes identifying security requirements for software features, identifying coding patterns to protect against vulnerabilities, identifying appropriate security test cases, finding vulnerabilities by identifying specific payloads, creating application security checklists, capturing application vulnerabilities in a database, linking application security vulnerabilities to features and threat models, correlating vulnerabilities with aliases for application security and deriving test cases from a vulnerability.

According to one embodiment herein, a database and methods are provided to capture application vulnerabilities. The embodiments herein enable linking application security vulnerabilities to features and threat models. The embodiments herein are also configured to correlate vulnerabilities with aliases and derive security test cases from a vulnerability.

According to one embodiment herein, an attack module is provided. The attack module is configured to predict attacks that exploit a particular vulnerability, by analyzing payloads and lists, recursive checklists and questions, recently exploited attacks and reference from attack examples. The module also comprises a vulnerability attack view module that provides access to per vulnerability attack checklists, security test cases, attack patterns and similar vulnerability exploits information from across the industry.

According to one embodiment herein, a vulnerability remediation module is provided. The remediation module is configured to access developer checklists, architect checklists and access to codes classified as good and bad. The remediation module is also configured to enable remediation in pipelines and strategic remediation. The vulnerability remediation information comprises good code/bad code classification, remediation checklists for developers, remediation principles, OWASP ASVS integration and auditor checklists for remediation.

According to one embodiment herein, a technology components module is provided. The technology components module is configured to correlate between a specific vulnerability and a plurality of technology components such as web servers. The technology components module is also configured to predictively identify the impact of the specific vulnerability on each of the plurality of technology components.

According to one embodiment herein, a vulnerability metadata module is provided. The module comprises a CWE module, a name module, a scoring module, related vulnerabilities information module, vulnerability aliases module, categories module and a compliance module. The categories module comprises information related to access control, authentication, data protection and monitoring. The compliance module comprises a plurality of sub-modules including information pertaining to GDPR, PCI-DSS, FINRA etc.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a block diagram of a system for identifying and fixing security vulnerabilities in an application, according to one embodiment herein.

FIG. 2 illustrates a flow diagram of a method for identifying and fixing security vulnerabilities in an application, according to one embodiment herein.

FIG. 3 illustrates a block diagram of a risk language library for identifying and fixing security vulnerabilities in an application, according to one embodiment herein.

FIG. 4 illustrates a system for organization, identification, classification and remediation of security vulnerabilities in computer applications, according to one embodiment herein.

FIG. 5 illustrates interrelationship hf the modules in the vulnerability classification and organization system.

FIG. 6 illustrates elements of the metadata module.

FIG. 7 illustrates elements of the remediation module.

FIG. 8 illustrates elements of the attack pattern module.

FIG. 9 illustrates elements of the threat model module.

Although the specific features of the embodiments herein are shown in some drawings and not in others. This is done for convenience only as each feature may be combined with any or all of the other features in accordance with the embodiment herein.

### DETAILED DESCRIPTION OF THE EMBODIMENTS HEREIN

The various embodiments of the embodiments herein provide a system and a method for identifying and fixing security vulnerabilities in an application. The embodiments herein also provide a system and a method that enables users to capture a plurality of information related to the vulnerabilities, identify and fix vulnerabilities in their applications with ease. The embodiments herein also provide methods that enable capturing common attack payloads to identify the vulnerabilities, capturing common security test cases to identify the vulnerability with automated and manual testing and capturing tactical and strategic fixes and remediation information for the vulnerability.

According to one embodiment herein, a system is provided for organization, identification, classification and remediation of security vulnerabilities in computer applications. The system comprises a plurality of computing devices and a digital storage mechanism. The computing devices are enabled to run computer applications. The digital storage mechanism is configured with a risk language library, wherein the digital storage mechanism is configured to communicably couple with the plurality of computing devices through wired or wireless means. The risk language library is configured to enable organization, identification, classification and remediation of security vulnerabilities in computer applications that run on the plurality of computing devices.

According to one embodiment herein, the risk language library 300 comprises a metadata module 103, a technology module 301, a features module 302, an examples module 303, a mitigations module 304, a breaches module 305, a bug bounty activity module 306 and a compliance module 307. The metadata module 103 further comprises sub-modules relating to common weakness enumerations (CWEs), related CWEs, name, description, aliases and common vulnerabilities and exposures (CVEs). The technology module 301 further comprises a component module that is sub-categorized based on characteristics such as name, payloads, hardening, questions, CVEs, categories, tools and advisories, and wherein the hardening is further sub-categorized as description, reference and advisory. The features module 302 further comprises sub-modules relating to feature name, feature type, impact and attributes. The examples module 303 further comprises a sub-module relating to code, and wherein the code is classified as good code and bad code. The mitigations module 304 is further sub-categorized, including generic mitigations by stage. The breaches module 305 further comprises sub-modules relating to name of the breach, attack vectors used by CWE and technique. The bug bounty activity module 306 further comprises sub-modules relating to bounty name, company, bounty date, technique and severity. The compliance module 307 further comprises sub-modules relating to standard name, standard identification reference and industry applicability.

According to one embodiment herein, the risk language library 300 is configured for identifying security requirements for software features and identifying coding patterns to protect against vulnerabilities. The risk language library 300 is also configured to enable security testers to identify appropriate security test cases, finding vulnerabilities by identifying specific payloads, creating application security checklists and provide training on application security for application developers.

According to one embodiment herein, the risk language library 300 is configured for capturing application vulnerabilities in a database, linking application security vulnerabilities to features and threat models, correlating vulnerabilities with aliases for application security and derive test cases from a vulnerability.

According to one embodiment herein, a method for organizing, identifying, classifying and remediating security vulnerabilities in computer applications. The method comprises the following steps: identifying approaches to find and exploit a vulnerability for fixing and remediating the vulnerability; determining impact and influence of the vulnerability on a product feature of the computer applications; identifying common remediation patterns per feature and approaches to attack feature through common vulnerabilities; and determining common threat models to a feature and common attacks leading to threat models.

According to one embodiment herein, identifying approaches to find and exploit a vulnerability for fixing and remediating the vulnerability further includes identifying security requirements for software features, identifying coding patterns to protect against vulnerabilities, identifying appropriate security test cases, finding vulnerabilities by identifying specific payloads, creating application security checklists, capturing application vulnerabilities in a database, linking application security vulnerabilities to features and threat models, correlating vulnerabilities with aliases for application security and deriving test cases from a vulnerability.

According to one embodiment herein, a database and methods are provided to capture application vulnerabilities. The embodiments herein enable linking application security vulnerabilities to features and threat models. The embodiments herein are also configured to correlate vulnerabilities with aliases and derive security test cases from a vulnerability.

According to one embodiment herein, an attack module is provided. The attack module is configured to enumerate attacks that exploit a particular vulnerability, by analyzing payloads and lists, recursive checklists and questions, recently exploited attacks and reference from attack examples. The module also comprises a vulnerability attack view module that provides access to per vulnerability attack checklists, security test cases, attack patterns and similar vulnerability exploits information from across the industry.

According to one embodiment herein, a vulnerability remediation module is provided. The remediation module is configured to access developer checklists, architect checklists and access to codes classified as good and bad. The remediation module is also configured to enable remediation in pipelines and strategic remediation. The vulnerability remediation information comprises good code/bad code classification, remediation checklists for developers, remediation principles, OWASP ASVS integration and auditor checklists for remediation.

According to one embodiment herein, a technology components module is provided. The technology components module is configured to correlate between a specific vulnerability and a plurality of technology components such as web servers. The technology components module is also configured to predictively identify the impact of the specific vulnerability on each of the plurality of technology components.

According to one embodiment herein, a vulnerability metadata module is provided. The module comprises a CWE module, a name module, a scoring module, related vulnerabilities information module, vulnerability aliases module, categories module and a compliance module. The categories module comprises information related to access control, authentication, data protection and monitoring. The compliance module comprises a plurality of sub-modules including information pertaining to GDPR, PCI-DSS, FINRA etc.

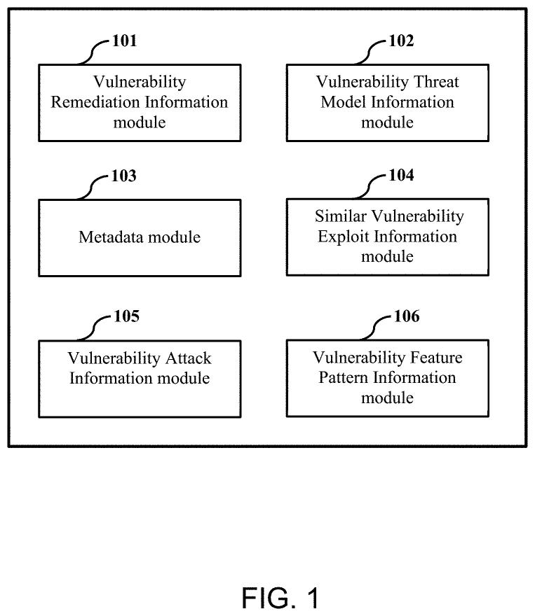

FIG. 1 illustrates a block diagram of a system for identifying and fixing security vulnerabilities in an application. The system comprises Vulnerability Remediation Information module 101, Vulnerability Threat Model Information module 102, Metadata module 103, Similar Vulnerability Exploit Information module 104, Vulnerability Attack Information module 105, Vulnerability Feature Pattern Information module 106.

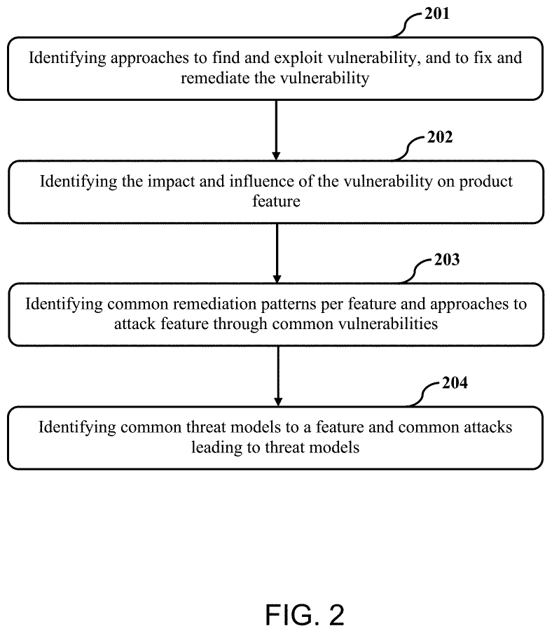

FIG. 2 illustrates a flow diagram of a method for identifying and fixing security vulnerabilities in an application. The method comprises the following steps: identifying approaches to find and exploit vulnerability, and to fix and remediate the vulnerability (201); identifying the impact and influence of the vulnerability on product feature (202); identifying common remediation patterns per feature and approaches to attack feature through common vulnerabilities (203); and identifying common threat models to a feature and common attacks leading to threat models (204).

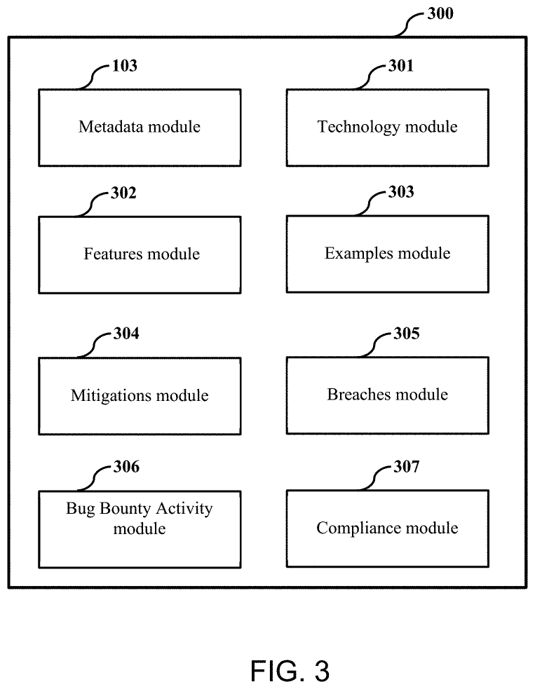

FIG. 3 illustrates a block diagram of a risk language library for identifying and fixing security vulnerabilities in an application. The risk language library comprises a Metadata module 103, a Technology module 301, a Features module 302, an Examples module 303, a Mitigations module 304, a Breaches module 305, a Bug Bounty Activity module 306 and Compliance module 307.

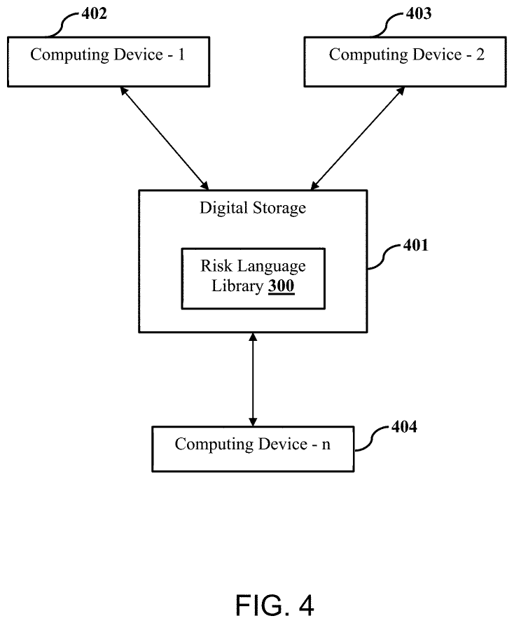

FIG. 4 illustrates a system for organization, identification, classification and remediation of security vulnerabilities in computer applications. The system comprises a Digital Storage mechanism 401 and a plurality of Computing Devices 402, 403, 404. The Digital Storage mechanism 401 is configured with a Risk Language Library 300 and configured to communicably couple with the plurality of computing devices 402, 403, 404 through wired or wireless means.

The various embodiments of the embodiments herein provide a system and a method for identifying and fixing security vulnerabilities in an application. The embodiments herein also provide a system and a method that enables users to capture a plurality of information related to the vulnerabilities, identify and fix vulnerabilities in their applications with ease. Currently available solutions only capture vulnerability information and some code information. They are not configured to handle application vulnerabilities linked with threat models, application vulnerabilities correlated with aliases and application security test cases generated from the vulnerability information. The embodiments herein provide methods for vulnerability remediation and enabling security training for developer application and identifying security requirements for software features. The embodiments herein also enable identifying appropriate security test cases and identify specific payloads to attack and find the vulnerability. The embodiments herein also provide methods that enable developers to identify coding patterns to protect against vulnerabilities and creating application security checklists.

An embodiment of the invention is directed to classifying and organizing software application security vulnerabilities for a variety of reasons. One reason is to be able to find all possible details relating to the software application security vulnerability in a single query. Another reason is to be able to query actionable information about a specific software application security vulnerability based upon vulnerability metadata, remediation information, features that might be affected by a particular vulnerability and threat model patterns and information based upon a particular vulnerability.

The focus of the invention is the system of organizing and classifying these details and not the specific details themselves. The details of the modules are available in the public domain. The manner in which the system is organized and classified is novel.

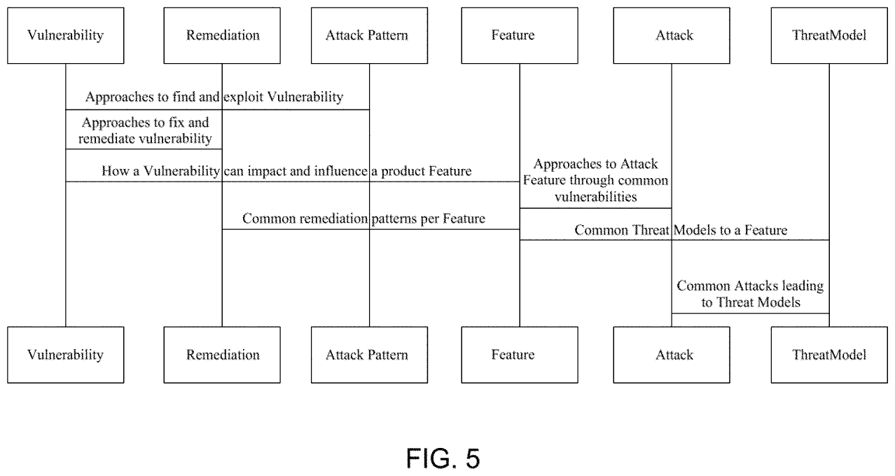

Set forth in FIG. 5 illustrates the interrelationships between the modules. There is a link associated with approaches to find and exploit vulnerabilities. There is a link associated with approaches to fix and remediate vulnerabilities. There is a link associated with how vulnerabilities impact and influence product features. There is a link between common remediation patterns per feature. There is a link associated with approaches to attack features through common vulnerabilities. There is a link between common threat models and features. There is a link between common attacks that leads to threat models.

Every software application security vulnerability has certain metadata attributes. This is the information that directly relates to describing the vulnerability and how it works. The metadata module typically has the following attributes relating to the vulnerability: (1) the name of the vulnerability, (2) the common weakness enumeration (CWE) identification of the vulnerability, (3) the description of the vulnerability, (4) the typical observations relating to the vulnerability and (5) the type of the vulnerability, which specifically relates to the vulnerability's family of flaws.

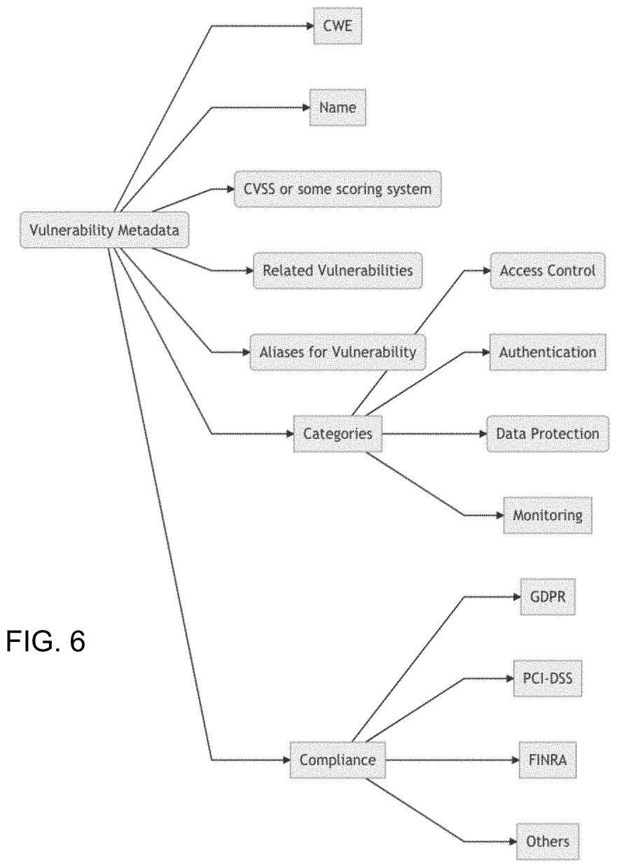

The relationship of the components is set forth in FIG. 6. In addition to the items set forth above, categories of the vulnerabilities include access control, authentication, data protection and monitoring. Compliance issues relating to the vulnerability metadata include GDPR, PCI-DSS, FINRA and others.

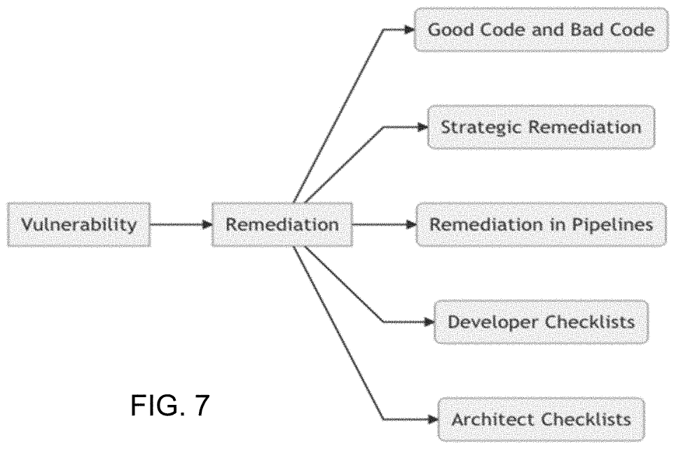

Functions of the remediation module, which is set forth in FIG. 7, include capturing and storing information relating to how the vulnerability is to be fixed or mitigated. The remediation module contains information relating to how the vulnerability is to be remediated by developers and operators. The remediation module typically includes: (1) description of the remediation approach to be taken, (2) details of the patch if applicable, (3) good code examples for the vulnerability, i.e., examples of source code that addresses the vulnerability, (4) bad code examples of the vulnerability, i.e., examples of unsecure source code implementation, and (5) references to existing security best practices that are oriented towards mitigating a specific vulnerability.

Software applications are replete with common feature patterns. Features such as login, list objects, checkout and shopping cart are some examples. The feature security module contains a reference to vulnerabilities that could affect these common feature patterns. This module contains the following attributes for each vulnerability: (1) name of the feature, (2) description of the feature, (3) how the feature is affected by the vulnerability, (4) how the vulnerability impacts the feature and (5) similar features to the specified feature.

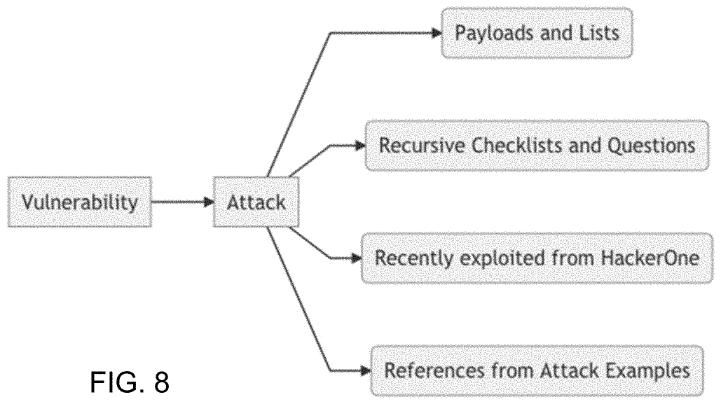

Functions of the attack pattern module are set forth in FIG. 8. Every vulnerability may be exploited by a threat actors that use specific attack vectors to perform a successful attack. In addition, the threat actors use specific attack paths and approaches to perform a successful attack. The following attributes are captures as part of the attack pattern module: (1) attack name, (2) attack description, (3) attack vectors utilized, (4) references to attack libraries such as CAPEC and MITRE, and (5) common attack paths and approaches.

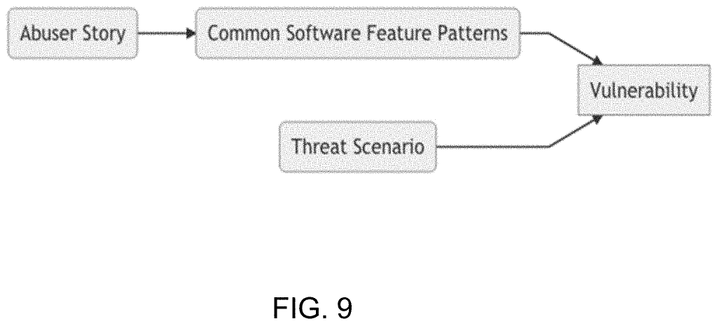

Functions of the threat model module are set forth in FIG. 9. A software application's threat module is a systematic capture of potential threats and countermeasures for a software application and its various features. In this module, threat modeling datasets are captures and then mapped back to the vulnerability in question. This process allows query patterns to be executed that correlate vulnerabilities to the associate threat models. The following attributes are captures as part of the threat model module: (1) abuser stories based upon feature user stories, (2) threat scenarios based on STRIDE and other threat modeling taxonomies and (3) impact of the threat scenario.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the disclosure with modifications. However, all such modifications are deemed to be within the scope of the appended claims.

It is also to be understood that the following claims are intended to cover all of the generic and specific features of the embodiments described herein and all the statements of the scope of the embodiments which as a matter of language might be said to fall there between.

1. A system for organization, identification, classification and remediation of security vulnerabilities in computer applications, the system comprising:
a plurality of computing devices, wherein the computing devices are enabled to run computer applications; and,
a digital storage mechanism configured with a risk language library, wherein the digital storage mechanism is configured to communicably couple with the plurality of computing devices through wired or wireless means, and wherein the risk language library is configured to enable organization, identification, classification and remediation of security vulnerabilities in computer applications that run on the plurality of computing devices.

2. The system according to claim 1, wherein the risk language library further comprises:
a metadata module, wherein the metadata module further comprises sub-modules relating to common weakness enumerations (CWEs), related CWEs, name, description, aliases and common vulnerabilities and exposures (CVEs);
a technology module, wherein the technology module further comprises a component module;
a features module, the features module further comprises sub-modules relating to feature name, feature type, impact and attributes;
an examples module, wherein the examples module further comprises a sub-module relating to code, and wherein the code is classified as good code and bad code;
a mitigations module, wherein the mitigations module is further sub-categorized, including generic mitigations by stage;
a breaches module, wherein the breaches module further comprises sub-modules relating to name of the breach, attack vectors used by CWE and technique;
a bug bounty activity module, wherein the bug bounty activity module further comprises sub-modules relating to bounty name, company, bounty date, technique and severity; and,
a compliance module, wherein the compliance module further comprises sub-modules relating to standard name, standard identification reference and industry applicability.

3. The system according to claim 2, wherein the technology module further comprises a component module that is sub-categorized based on characteristics such as name, payloads, hardening, questions, CVEs, categories, tools and advisories, and wherein the hardening is further sub-categorized as description, reference and advisory.

4. The system according to claim 1, wherein the risk language library is configured for identifying security requirements for software features and identifying coding patterns to protect against vulnerabilities, and wherein the risk language library is also configured to enable security testers to identify appropriate security test cases, finding vulnerabilities by identifying specific payloads, creating application security checklists and provide training on application security for application developers.

5. The system according to claim 1, wherein the risk language library is configured for capturing application vulnerabilities in a database, linking application security vulnerabilities to features and threat models, correlating vulnerabilities with aliases for application security and derive test cases from a vulnerability.

6. A method for organizing, identifying, classifying and remediating security vulnerabilities in computer applications, the method comprising:
identifying approaches to find and exploit a vulnerability for fixing and remediating the vulnerability;
determining impact and influence of the vulnerability on a product feature of the computer applications;
identifying common remediation patterns per feature and approaches to attack feature through common vulnerabilities; and,
determining common threat models to a feature and common attacks leading to threat models.

7. The method according to claim 6, wherein identifying approaches to find and exploit a vulnerability for fixing and remediating the vulnerability further includes identifying security requirements for software features, identifying coding patterns to protect against vulnerabilities, identifying appropriate security test cases, finding vulnerabilities by identifying specific payloads, creating application security checklists, capturing application vulnerabilities in a database, linking application security vulnerabilities to features and threat models, correlating vulnerabilities with aliases for application security and deriving test cases from a vulnerability.
